(19) United States
(12) Patent Application Publication
(10) Pub. No.: US 2020/0180221 A1
(43) Pub. Date: Jun. 11, 2020

(54) 3D PRINTER

(71) Applicant: HEWLETT-PACKARD DEVELOPMENT COMPANY, L.P., Houston, TX (US)

(72) Inventors: Oriol BORRELL CARBONELL, Sant Cugat del Valles (ES); Salvador SANCHEZ RIBES, Sant Cugat del Valles (ES); Gemma BOLUMAR BARRERA, Sant Cugat del Valles (ES)

(73) Assignee: HEWLETT-PACKARD DEVELOPMENT COMPANY, L.P., Houston, TX (US)

(21) Appl. No.: 16/098,409

(22) PCT Filed: Apr. 24, 2017
(86) PCT No.: PCT/US2017/029057

§ 371 Date: Nov. 1, 2018

(51) Int. Cl. B29C 64/209; B29C 64/295; B29C 64/35; B29C 64/357; B29C 64/227; B29C 64/393; B29C 64/106

(52) U.S. Cl. CPC B29C 64/209; B29C 64/295; B29C 64/35; B33Y 10/00; B29C 64/227; B29C 64/393; B29C 64/106; B29C 64/357

(57) ABSTRACT

Examples relate to a 3D printer capable of positioning a printhead relative to a spittoon disposed within a maintenance region of the 3D printer, ejecting printing fluid from the printhead onto the spittoon, and positioning a moveable heat source proximate to the spittoon to evaporate printing fluid from the spittoon.

### BACKGROUND

Three dimensional printers are revolutionising additive manufacturing. Such 3D printers can provide a harsh operating environment.

### BRIEF INTRODUCTION OF THE DRAWINGS

Examples implementations are described below with reference to the accompanying drawings, in which:

FIG. 1 shows a schematic diagram of a 3D printer according to some examples;

FIGS. 2A to 2E illustrate multiple stages of spittoon heating according to some examples;

FIG. 3 depicts an example of a method according to some examples;

FIG. 4 shows a schematic diagram of a further 3D printer according to some examples;

FIGS. 5A to 5C illustrate multiple stages of spittoon cleaning according to some examples;

FIG. 6 depicts an example of a method according to some examples; and

FIG. 7 shows machine readable storage and machine executable instructions according to an example.

### DETAILED DESCRIPTION

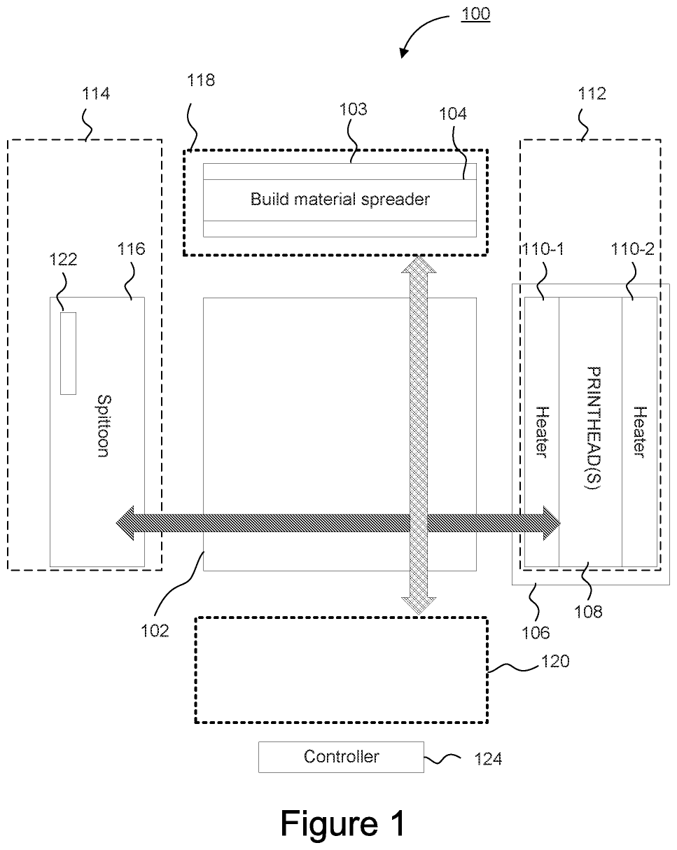

FIG. 1 schematically illustrates a plan view of a 3D printer 100. The 3D printer 100 comprises: a working area 102 in which a three-dimensional object can be generated. The working area is an example of a printing region. Example implementations can be realised in which the working area 102 forms part of a removable build unit that can be inserted into and removed from the printer 100. Alternatively, example implementations can be realised in which the working area 102 is an integral part of the printer 100 as opposed to being part of a removable build unit. The printer 100 further comprises a build material carriage 103 bearing a build material spreader 104. In example implementations, the build material spreader 104 creates a layer of build material, which can be in the form of a powder, from which an object can be incrementally built. Examples can be realised in which the build material spreader spreads build material over the working area to form such a layer. A printhead carriage 106 is also provided. The printhead carriage 106 comprises at least one printhead 108 for printing at least one printing fluid. Examples can be realised in which the printhead carriage 106 comprises a number of printheads 108. The printheads 108 can be arranged to deposit respective printing fluids on associated layers of build material. For example, the printing fluids can comprises at least one or more of a fusing agent, a detailing agent, one or more coloured inks, a transparent agent, or a printing agent comprising a dopant taken jointly and severally in any and all permutations. Examples of a printing agent bearing a dopant can comprise a printing agent bearing a material to influence or change at least one or more of the elastic or electrical properties of the build material. Agents are examples of liquids. The term fluid will be used throughout the specification and is intended to encompass the term agent. The printhead carriage 106 can also be provided with one or more heaters 110. In the depicted example, the printhead carriage 106 bears two heaters 110-1 and 110-2. The one or more heaters 110 can be realised using, for example, infrared (IR) heaters. A fusing lamp is an example of such an IR heater. Halogen lamps can be used to realise such a fusing lamp. A heater is an example of a heat source.

The printhead carriage 106, in this example, is arranged to traverse the working area 102 in a reciprocating manner. While traversing the working area 102, the printheads 108 can print printing fluids onto a layer of build material formed by the build material spreader 104. The printheads 108 can use an array of nozzles (not shown) to deposit the printing fluids.

Having printed one or more than one printing fluid onto a layer of build material, the heaters 110 can be used to influence the temperature of the build material according to the printed printing fluid. For example, the build material can be heated via the printed printing fluid to cause the build material to fuse together or otherwise agglomerate. The heaters 110 can be arranged to heat the printed printing fluid concurrently with printing the printing fluid, that is, during the same traversal of the working area, or during a separate or further traversal of the working area.

A stowage area 112 can be provided to one side of the working area 102. The printhead carriage 106 can be stowed in the stowage area 112 between printing or heating traversals. The stowage area 112 can be arranged to cool the printheads 108.

A maintenance area 114 can be provided to another side of the working area 102. The maintenance area 114 is an example of a maintenance region. The maintenance area 114 comprises a spittoon 116 for receiving one or more than one printing fluid during one or a number of maintenance operations. Examples can be provided in which the maintenance operations comprise ejecting or expelling printing fluid from one or more than one of the printheads 108. Maintenance operations such as, for example, spitting a printing fluid, purging a printing fluid, printing a printing fluid, flushing a printing fluid, wiping a printing fluid are examples of such ejecting or expelling printing fluids.

The spittoon 116 can be fabricated from metal or a ceramic that can be heated by the one or more heaters 110. Implementations can be realised in which the spittoon 116 is substantially planar, or at least bears a substantially planar printing fluid receiving surface. The material from which the spittoon 116 is fabricated can have a melting point that is above one or more temperatures encountered within, or during the operation of, the 3D printer 100. For example, implementations can be realised in which the melting point of the material from which the spittoon 116 is fabricated is sufficiently high to not melt, undergo a phase change or undergo a chemical reaction as a consequence of such temperatures countered within, or during the operation of, the 3D printer 100. Such a chemical reaction can comprise burning. Particular implementations can be realised in which the spittoon 116 does not melt, otherwise undergo a phase change or undergo a chemical reaction due to temperatures associated with the one or more heaters 110. Accordingly, implementations can be realised in which the one or more than one heater 110 can be used for multiple purposes comprising heating printing fluid deposited onto build material and heating printing fluid deposited on the spittoon 116 for maintenance operations.

Although the examples have been, or are, described with reference to separate stowage 112 and maintenance 114 areas, examples can alternatively be realised in which the stowage 112 and maintenance 114 areas are one and the same, which means a single such area can be provided as opposed to two such areas.

The build material carriage 103 is arranged, in this example, to traverse the working area in a reciprocating manner. Build material can be laid or otherwise deposited via the build material spreader 104 during any or all such traversals. In the example shown, the build material carriage 103 is moveable between two end positions 118 and 120.

Although the examples described have used, or use, one or more than one heater 110 carried by the printhead carriage 106, examples can, alternatively or additionally, be realised in which one or more than one heater is carried by the build material carriage 103. Locating the one or more than one heater distally relative to the printheads 108 can have the effect of reducing the heating of the printing fluids within the printheads 108.

Furthermore, any or all examples described can be realised in which one or more than one heater 110 is provided on the build material carriage 103 and the printhead carriage 106, with the heaters 110 being operable at selectable temperatures. For example, such one or more heaters 110 on the build material carriage 103 can be operated at a higher temperature relative to the one or more heaters 110 on the printhead carriage 106. In such an example, the heater or heaters 110 on the build material carriage 103 can be arrange to supply the majority of the energy used in raising the temperature of the build material to a pre-fusing or priming temperature, that is, the temperature of the build material in the working area 102 can be increased without fusing or otherwise agglomerating the build material and the heater or heaters 110 of carried by the printhead carriage 106 can be used to raise further the temperature of the build material bearing printing fluid, such as the fusing agent, to a temperature at, or beyond, which fusing occurs. Such an example can use lower power heaters on the printhead carriage 106, which may reduce the number of maintenance operations since, for example, the printing fluid in the printheads may evaporate or clog less frequently due to the lower temperatures of the adjacent heater or heaters.

Producing a 3D object comprises the build material spreader 104 laying down a layer of build material in the working area 102 by passing between the end positions 118 and 120. After depositing a layer of the build material, the printhead carriage 106 traverses the working area selectively depositing printing fluids such as, for example, a fusing agent in areas or positions where particles of the build material are intended to be to fused together. A detailing agent may also be selectively applied where the fusing action is to be reduced or amplified. Different detailing agents may be used for such reduction and amplification. For example, the detailing agent may be selectively applied in a pattern relative to the fusing agent such that it reduces fusing at a boundary between build material in an area to be fused and build material not to be fused, which can create a more differentiated or sharper edge to any fused material.

Examples can be realised in which any given carriage, such as, one or more of the build material carriage 103 and the printhead carried 106, comprises a pair of heaters, namely, a leading edge heater and a trailing edge heater according to the direction of the travel of the respective carriage. In such examples, the heaters can be selectively operated. Implementations can be realised in which, for example, the trailing edge heater is used to heat build material after the printhead or printheads have deposited printing fluids onto the build material. Alternatively or additionally, the leading edge heater can pre-heat the build material in advance of the printhead or printheads depositing the printing fluid.

The process of depositing build material, depositing one or more than one printing fluid and heating the printed build material can be repeated in successive layers until a complete 3D object has been generated. This process can operate using multiple printhead jets/nozzles to apply, simultaneously in some implementations, the fusing and detailing agents to the build material.

The environment within which the printheads 108 operate is harsh in that the operating temperatures, for example, can adversely affect the printing fluids within the printheads 108 or within conduits (not shown) leading to the printheads 108, especially in off axis printheads. Therefore, the above mentioned maintenance operations can be effected to counter any such adverse reactions of the printing fluids. Suitably, the printhead carriage 106 can be moved to the maintenance area 114 for maintenance operations. Within the maintenance area 114, the one or more than one printhead 108 can be operating to eject or otherwise expel a respective printing fluid onto the spittoon 116, more particularly, onto a printing fluid receiving surface of the spittoon 116. The spittoon 116 is heated. The heated spittoon 116 evaporates any printing fluid, which leaves a printing fluid residue on the spittoon 116. An example of such a printing fluid residue 122 is shown on the spittoon 116. The printing fluid residue 122 can be associated with, for example, printing fluid ejected from an array of printhead nozzles (not shown).

The operations performed by the 3D printer 100 can be controlled via a controller 124. The controller 124 can comprise one or more processors, or other circuitry, for executing instructions for controlling the 3D printer 100. Therefore, the controller 124 can control at least one or more of moving the printhead carriage 106, printing print fluid from the printheads 108, moving the build material carriage 103, depositing build material from the build material spreader 104, maintenance operations, printing operations, heating operations etc. taken jointly and severally in any and all permutations.

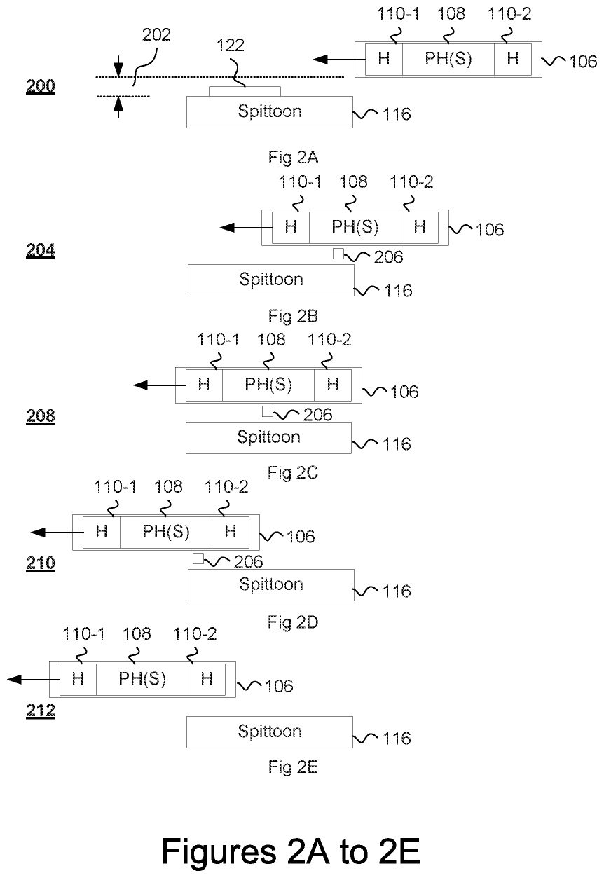

FIGS. 2A to 2E show numerous front views of different relative positions of the spittoon 116 and the printhead carriage 106 bearing the printheads 108 and heaters 110.

A first view 200 shows the printhead carriage 106 approaching the spittoon 116 in the direction indicated by the arrow. The printhead carriage 106 and the spittoon 116 are separated by a predetermined normal or vertical distance 202. The predetermined distance 202 allows a layer of printing fluid residue 122 to accumulate without risk of the accumulated printing fluid residue 122 interfering with the movement of the printhead carriage 106. The spittoon 116 can be fabricated from a metal or a ceramic that can be heated by the one or more heaters 110. As the heater or heaters 110 pass over the spittoon 116, at least one of any printing fluid and the spittoon per se will be heated, which results in evaporating the printing fluid.

A second view 204 is shown in which one or more than one printhead 108 passes over the spittoon 116. During such a transition of over the spittoon 116, the one or more printheads 108 eject printing fluid 206 onto the spittoon 116 for subsequent evaporating. Ejecting the printing fluid 206 onto the spittoon 116 can be effected as a consequence of any or more of the above described maintenance operations. Ejecting printing fluid 206 onto the spittoon 116 can occur whilst the printheads are disposed above the spittoon 116 as shown in third and fourth views 208 and 210.

A fifth view 212 is shown in which the printhead carriage 106 ceases traversing the spittoon 116 in the direction indicated by the arrow. In the implementation shown, the trailing edge heater 110-2 remains above the spittoon 116 and does not transit past the spittoon 116.

During the transit of the heater or heaters 110 over the spittoon 116, the heaters evaporate printing fluid 206 leaving printing fluid residue 122 on the spittoon 116.

Implementations can be realised in which ejecting printing fluid 206 onto the spittoon 116 can be unidirectional or bidirectional. In the case of bidirectional implementations, the operations shown in, or described with reference to, any of views 200, 204, 208, 210, and 212, taken jointly and severally in any and all permutations, can be repeated or realised, with the arrow representing an opposite direction of travel to that described above.

Although the implementations described have been, or can be, realised in which at least one heater 110 fully passes the spittoon 116, implementations can alternatively be realised in which the printhead carriage 106 stops a pass over the spittoon 116 such that is it disposed above the latter such as shown in view 208 and then changes direction of travel.

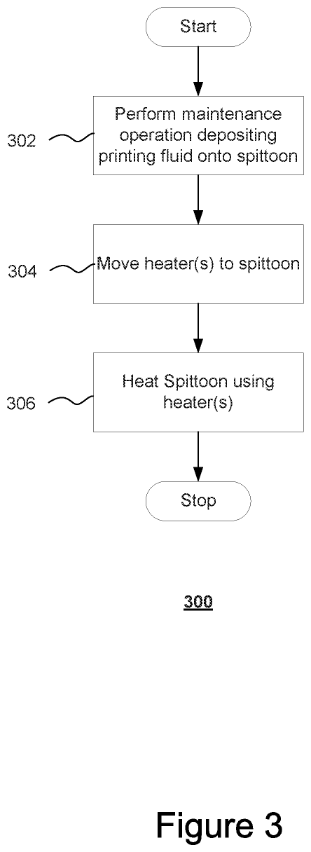

FIG. 3 shows a flowchart 300 of processing or activities undertaken by a 3D printer 100 according to implementations. The processing or activities can comprise, at 302, ejecting or expelling at least one printing fluid from at least one printhead onto the spittoon 116. Implementations can be realised in which a number of printing fluids are ejected or expelled from respective printheads onto the spittoon 116. Ejecting printing fluid(s) at 302 is followed, at 304, by, preceded by, or both, positioning the heater or heaters 110 relative to the spittoon 116 and, at 306, heating at least one of the spittoon 116 and any ejected printing fluid 206 using the heater or heaters 110, which results in evaporating any ejected printing fluid 206. Evaporating any printing fluid on the spittoon 116 leaves respective printing fluid residue 122.

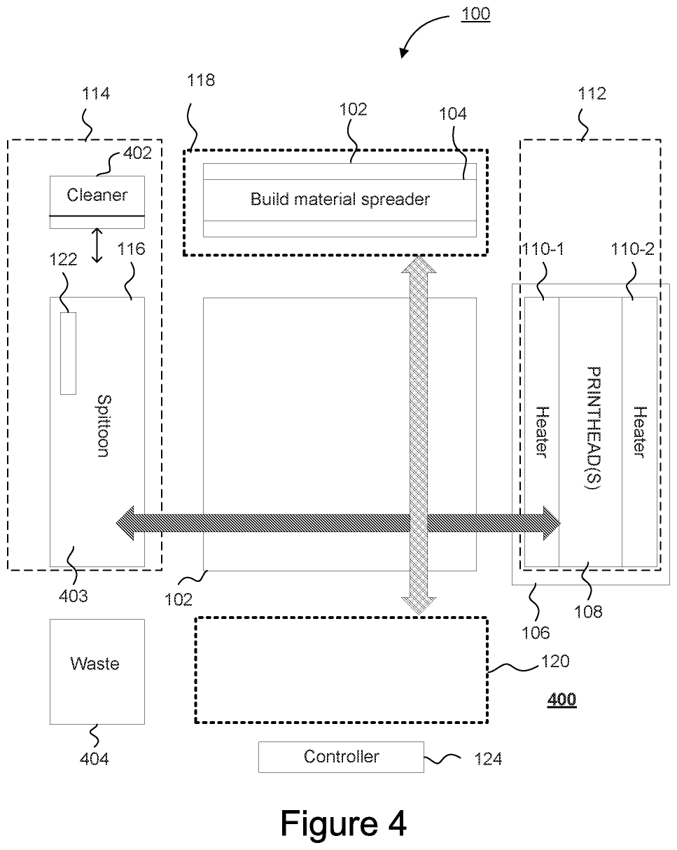

Referring to FIG. 4, there is shown a plan view 400 of the above described 3D printer 100 with additional components according to an implementation. Reference numerals depicted in FIG. 4 that are common to FIG. 1 refer to the same features. The 3D printer 100 further comprises a cleaner 402 for cleaning the spittoon 116. In the implementation shown, the cleaner 402 is realised in the form of a blade that traverses the printing fluid receiving surface 403 of the spittoon 116. The cleaner 402 removes printing fluid residue 122 from the spittoon 116. The printer fluid residue 122 removed from the spittoon 116 can be accumulated in a waste receptacle 404. The waste receptacle 404 can be emptied from time to time.

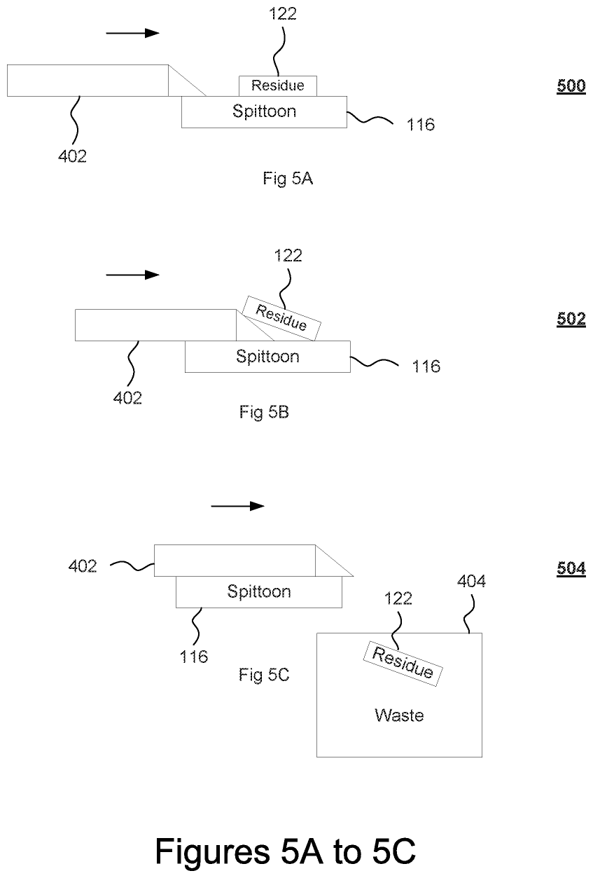

Referring to FIGS. 5A to 5C, there are shown views 500 to 504 of cleaning operations according to implementations. A first view 500 of a cleaning operation shows the cleaner or blade 402 advancing in the direction indicated by the arrow consequently scraping or otherwise cleaning the printing fluid receiving surface 403 of the spittoon 116. A second view 502 depicts the printing fluid residue 122 being lifted or otherwise removed from the spittoon 116. Finally, a third view 504 shows the removed printing fluid residue 122 being deposited into the waste receptacle 404.

Alternatively or additionally, in any and all implementations, the spittoon 116 can be removed, cleaned and replaced, which realises a more environmentally friendly 3D printer 100. Any such removing, cleaning and replacing can be performed manually.

Implementations can be realised in which the spittoon 116 is inverted in situ prior to cleaning such that the cleaner 402 is disposed within a region of the 3D printer 100 other than the maintenance area 114 adjacent to the working area 102. Accordingly, the depicted stages of FIGS. 5A to 5C will be inverted. In such an implementation the waste receptacle 404 can be disposed below the inverted spittoon 116 to catch any falling printing fluid residue 122.

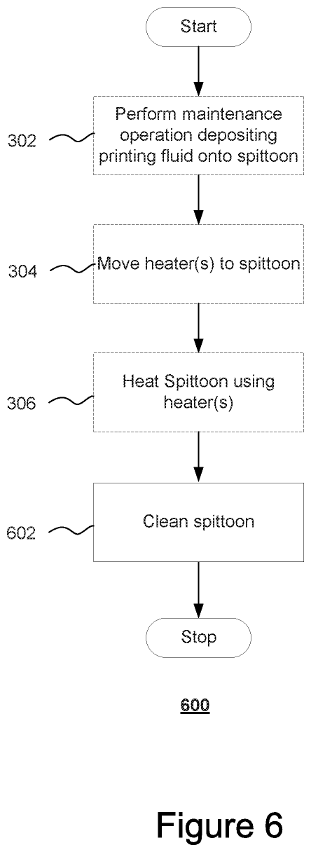

Referring to FIG. 6, there is shown a view 600 of a flowchart of processing or activities undertaken by a 3D printer 100 according to implementations. Reference numerals depicted in FIG. 6 that are common to FIG. 3 refer to the same features. Such common features have been depicted using dashed line boxes to indicate that any or all of those features described with reference to FIG. 3 are optional to the implementation shown in, or described with reference to, FIG. 6. When the controller 124 determines that a cleaning operation is to be performed, the cleaner 404, at 602, is actuated to clean the spittoon 116 by removing printing fluid residue 122 from the spittoon 116. Therefore, example implementations can be realised in which the cleaner is cleaned at least one of manually and automatically.

Example implementations can be realised in the form of machine executable instructions arranged, when executed by a machine, to implement any or all of the aspects, processes, activities or flowcharts, taken jointly and severally in any and all permutations, described in this application. Therefore, implementations also provide machine readable storage storing such machine executable instructions. The machine readable storage can comprise non-transitory storage. The machine can comprise one or more processors or other circuitry for executing the instructions. For example, the controller 124 can process any such machine executable instructions.

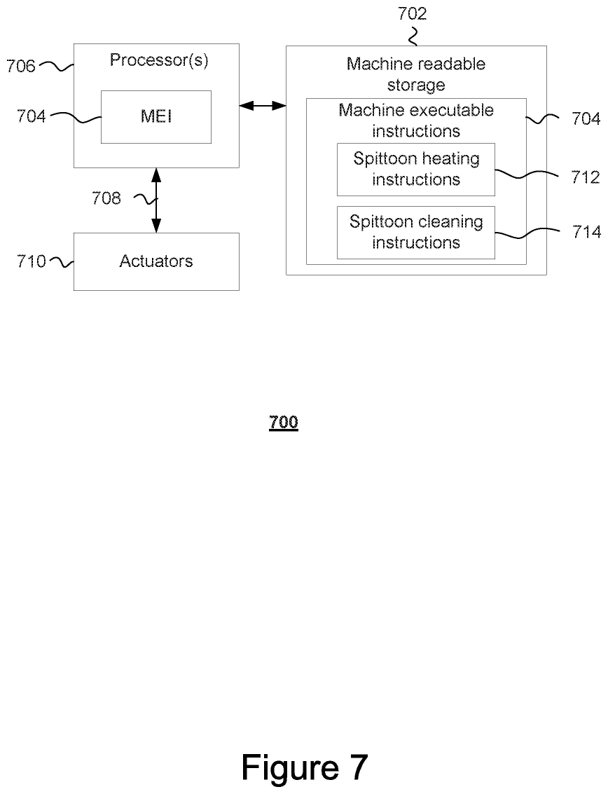

Referring to FIG. 7, there is shown a view 700 of implementations of at least one of machine executable instructions or machine readable storage. FIG. 7 shows machine readable storage 702. The machine readable storage 702 can be realised using any type of volatile or non-volatile storage such as, for example, memory, a ROM, RAM, EEPROM, optical storage and the like. The machine readable storage 702 stores machine executable instructions (MEIs) 704. The MEIs 704 comprise instructions that are executable by a processor or other instruction execution circuitry 706. The processor or other circuitry 706 is responsive to executing the MEIs 704 to perform any and all activities, operations, methods described and claimed in this application.

The processor or other circuitry 706 can output control signals 708 for influencing the operation of one or more than one actuator 710 for performing any and all operations, activities or methods described and claimed in this application. The MEIs 704 can comprise at least one of, or both of, machine executable instructions 712 for performing maintenances operations using the heated spittoon 116 and machine executable instructions 714 for cleaning operations described and claimed in this application.

The controller 124 can be an implementation of the foregoing processor or other circuitry 706 for executing any such MEIs 704. Suitably, implementations can be realised in the form of a controller for a 3D printer in which the controller comprises circuitry to control movement of the printhead to the maintenance region for ejecting printing fluid onto the printing fluid receiving surface of the spittoon; circuitry to control printing of printing fluid from the printhead onto the printing fluid receiving surface, and circuitry to control heating, using the heat source, of the printing fluid receiving surface to evaporate the printing fluid from said surface.

Although the implementations described or claimed in this specification intentionally position the one or more than one heater 110 so as to heat the spittoon 116, implementations are not limited to such arrangements. Implementations can be realised in which the one or more heaters 110 remain in an on state during maintenance operations, which can, therefore, heat the spittoon as an inevitable or natural consequence of the proximity of the one or more than one heater 110 to the spittoon 116. Therefore, stages 304 and 306 can be intentional in that the heaters are moved to heat the spittoon or an inevitable consequence in that the one or more heaters 110 are sufficiently proximate to the spittoon 116 to evaporate any printing fluid deposited onto the spittoon 116.

Any or all of the implementations described or claimed in this application can move the one or more than one heater 110 to heat the spittoon separately or independently of performing a maintenance operation such as one or more than one of spitting, purging, flushing, wiping etc. Therefore, in the flowcharts of FIGS. 3 and 6, stage 302 can be optional to realise intentionally heating the spittoon independently of any maintenance operations.

Example implementations can be realised according to one or more of the following examples.

Example 1 provides a 3D printer for printing using a build material, the printer comprising a print head, moveable between a printing region and a maintenance region, for printing at least one printing fluid on build material within the printing region, a heat source for fusing build material bearing printing fluid, and a spittoon, disposed within the maintenance region, comprising a printing fluid receiving surface for accumulating printing fluid residue of evaporated printing fluid; wherein the surface has a melting point above a predetermined operating temperature of the heat source and wherein the heat source can be positioned relative to the surface to cause evaporation of the printing fluid from the printing fluid receiving surface.

Example 2 provides a printer of example 1, in which the heat source is a fusing lamp for fusing build material bearing printed printing fluid.

Example 3 provides a printer of either of examples 1 and 2, in which a predetermined distance is provided between the printing fluid receiving surface of the spittoon and the print head to accommodate accumulated printing fluid residue.

Example 4 provides the printer of any preceding example, in which the spittoon is a metallic or ceramic spittoon.

Example 5 provides the printer of example 4, in which the spittoon bears a substantially planar metal or ceramic printing fluid receiving surface.

Example 6 provides the printer of any preceding example, in which the spittoon is a receptacle comprising the printing fluid receiving surface.

Example 7 provides the printer of any preceding example, in which the spittoon is at least one of removable, cleanable, replaceable and recyclable.

Example 8 provides a method of controlling a 3D printer; the method comprising placing a printhead relative to a spittoon disposed within a maintenance region of the 3D printer, ejecting printing fluid from the printhead onto the spittoon, and positioning a moveable heat source proximate to the spittoon to evaporate printing fluid from the spittoon.

Example 9 provides the method of example 8, comprising removing print fluid residue, resulting from evaporating printing fluid, from the spittoon.

Example 10 provides the method of either of examples 8 and 9, in which disposing the printhead relative to the spittoon comprising moving the printhead into the maintenance region prior to ejecting printing fluid from the printhead.

Example 11 provides the method of any of examples 8 to 10, in which the printhead and the heat source are carried by a carriage, the method comprising moving the carriage between a printing region of the 3D printer and the maintenance region.

Example 12 provides Machine readable storage storing machine executable instructions arranged, when executed, to implement the method of any of examples 8 to 11.

Example 13 provides a controller for a 3D printer of any of examples 1 to 7; the controller being arranged: to control movement of the printhead to the maintenance region for ejecting printing fluid onto the printing fluid receiving surface of the spittoon; to control printing of printing fluid from the printhead onto the printing fluid receiving surface, and to control heating, using the heat source, of the printing fluid receiving surface to evaporate the printing fluid from said surface.

Example 14 provides the printer of any of examples 1 to 7, in which the printing region comprises a working area. The working area can be removable. The working area can form part of a removable build unit.

Throughout the description and claims of this application, the words “comprise” and “contain” and variations of them mean “including but not limited to”, and they are not intended to (and do not) exclude other moieties, additives, components, integers or steps. Throughout the description and claims of this application, the singular encompasses the plural unless the context otherwise requires. In particular, where the indefinite article is used, the specification is to be understood as contemplating the plural as well as the singular, unless the context requires otherwise.

1. A 3D printer for printing using a build material, the printer comprising at least one print head, moveable between a printing region and a maintenance region, for printing at least one printing fluid onto build material within the printing region, a heat source for fusing build material bearing printing fluid, and a spittoon, disposed within the maintenance region, comprising a printing fluid receiving surface for accumulating printing fluid residue of evaporated printing fluid; wherein the surface has a melting point above a predetermined temperature associated with the heat source and wherein the heat source can be positioned relative to the spittoon to cause evaporation of the printing fluid from the printing fluid receiving surface.

2. The printer of claim 1, in which the heat source is a fusing lamp for fusing build material bearing printed printing fluid.

3. The printer of claim 1, in which a predetermined distance is provided between the printing fluid receiving surface of the spittoon and the print head to accommodate accumulated printing fluid residue resulting from said evaporation.

4. The printer of any preceding claim, in which the spittoon is made of a metal or ceramic.

5. The printer of claim 4, in which the spittoon bears a substantially planar metal or ceramic printing fluid receiving surface.

6. The printer of any preceding claim, in which the spittoon is a receptacle comprising the printing fluid receiving surface.

7. The printer of any preceding claim, in which the spittoon is at least one of removable, cleanable, replaceable and recyclable.

8. The printer of claim 1, in which the printing region comprises a working area.

9. The printer of claim 8, in which the working area is removable.

10. A method of controlling a 3D printer; the method comprising:
a. placing a printhead relative to a spittoon disposed within a maintenance region of the 3D printer,
b. ejecting printing fluid from the printhead onto the spittoon, and
c. positioning a moveable heat source proximate to the spittoon to evaporate printing fluid from the spittoon.

11. The method of claim 10, comprising removing printing fluid residue, resulting from evaporating printing fluid, from the spittoon.

12. The method of either of claims 10 and 11, in which disposing the printhead relative to the spittoon comprising moving the printhead into the maintenance region to eject printing fluid from the printhead onto the spittoon.

13. The method of claim 10, in which the printhead and the heat source are carried by a carriage, the method comprising moving the carriage between a printing region of the 3D printer and the maintenance region.

14. Machine readable storage storing machine executable instructions arranged, when executed, to implement the method of any of claims 10 to 13 or to control the printer of any of claims 1 to 9.

15. A controller for a 3D printer of any of claims 1 to 9; the controller comprising:
circuitry to control movement of the printhead to the maintenance region for ejecting printing fluid onto the printing fluid receiving surface of the spittoon;
circuitry to control printing of printing fluid from the printhead onto the printing fluid receiving surface, and
circuitry to control heating, using the heat source, of the printing fluid receiving surface to evaporate the printing fluid from said surface.
